(19) United States
(12) Patent Application Publication
(10) Pub. No.: US 2011/0055692 A1
(43) Pub. Date: Mar. 3, 2011

(54) DIGITAL MEDIA DEVICE AND METHOD FOR MANAGING DATA FOR THEREON

(75) Inventors: Li LI, Shanghai (CN); Liang Huang, Shanghai (CN); Shih-Kuang Tsai, Shanghai (CN)

(73) Assignees: INVENTEC APPLIANCES (Shanghai) CO., LTD.; INVENTEC APPLIANCES CORP.

(21) Appl. No.: 12/794,112

(22) Filed: Jun. 4, 2010

(30) Foreign Application Priority Data
Aug. 28, 2009 (CN) 200910194774.1

(51) Int. Cl. G06F 3/048; G06F 17/21

(52) U.S. Cl. 715/273; 715/764; 715/806

(57) ABSTRACT

An algorithm is implemented on a digital media device (10) for managing and compiling data for display on the device (10). When a user tracks or marks passages in a file on display, the device (10) stores the user marked passages in a nonvolatile memory block (46). When the user enters data while reading the file, and the device (10) stores the user entered data in another nonvolatile memory block (48). At the user's request, the device (10) compiles and displays the marked passages, the user entered data, or both. In addition, the algorithm can generate a coordinate representing the location in the file where the user enters the data, thereby by establishing a correspondence between the user entered data and the content of the file.

### FIELD OF THE INVENTION

The present invention generally relates to data management for display and, more particularly, to customizing the display on a digital media device.

### BACKGROUND OF THE INVENTION

Electronic books, which are also referred to as e-books or eBooks, are digital media equivalents of conventional printed books. Numerous e-book formats have emerged and proliferated, some supported by major software companies such as Adobe's PDF format, and others supported by independent and open-source programmers. Compared with conventional printed books, e-books are significantly lighter in weight and smaller in size. A single e-book may store the contents of several hundred printed books. Font size and font face can generally be adjusted on e-books for easy reading, especially for the readers with impaired visions.

An e-book device, which is often referred to as an e-book reader, is a device used to display e-books. It may be a device specifically designed for that purpose, or one intended for other purposes as well. For example, a personal data assistant (PDA) capable of displaying text on a screen is capable of being an e-book reader. The main advantages of these devices are portability and long battery life.

Readers sometimes like to make notes while reading books. When reading a printed book, the readers generally make the notes at the right margin of the pages. Readers sometimes also like to highlight certain passages in a book for later reading or reference. For printed books, this can be achieved by using a highlight marker to cover the passages or using a pen or pencil to underline or circle the passages. Making notes and/or highlight texts books are widely adopted by the those reading study materials and technical documents.

Early types of e-books on the market generally have a single function of displaying the book content. They do not allow readers to write down notes or mark the texts for later reviews. Another type of e-books on the market now allows the readers to write down notes. The e-book will display the reader's notes together with the original book content in a way similar to case when the readers write notes on the margins of the printed books. Like the notes on the printed books, when the reader write notes on the e-book repeatedly, the e-book will display all notes together with the original book content. Therefore, the e-book display may become chaotic or even illegible after successive notes writing. If several readers read the same e-book and all take notes, the e-book display may become too messy to be illegible to any single reader.

Accordingly, it would be advantageous to have a digital media device and a method for managing data for display on the digital media device. It is desirable if a user can enter data into the digital media device and later select at least a portion of the entered data for display. It is also desirable for the user to be able to mark portions of the content stored in the digital media device and later selectively display the marked contents. It would be of further advantage for the digital media device to be able to display a combination of selected user entered data and selected marked content.

### BRIEF DESCRIPTION OF THE DRAWINGS

FIG. 1 is a functional block diagram illustrating a digital media device in accordance with an embodiment of the present invention;

FIG. 2 is a block diagram illustrating a functional structure of a data storage unit in a digital media device in accordance with an embodiment of the present invention;

FIG. 3 is a flowchart illustrating a data management process in accordance with an embodiment of the present invention; and

FIG. 4 is a flowchart illustrating a process for compiling and displaying marked passage and notes in accordance with an embodiment of the present invention.

### DETAILED DESCRIPTION OF VARIOUS EMBODIMENTS

Various embodiments of the present invention are described herein below with reference to the figures, in which elements of similar structures or functions are represented by like reference numerals throughout the figures. It should be noted that the figures are only intended to facilitate the description of various embodiments of the present invention. They are not intended as an exhaustive description of the present invention or as a limitation on the scope of the present invention.

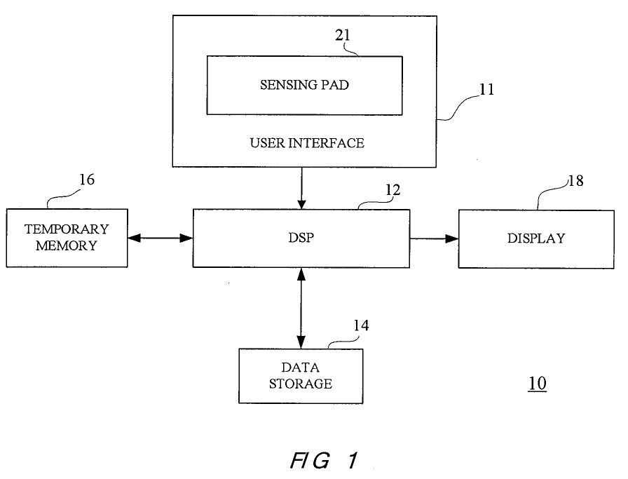

FIG. 1 is a functional block diagram illustrating an electronic device 10 in accordance with an embodiment of the present invention. It should be noted that FIG. 1 shows only those elements in device 10 necessary for the description of the structure and operation of device 10 in accordance with a preferred embodiment of the present invention. By way of example, electronic device 10 may be a digital media device that is often referred to as an electronic book, an e-book, or simply an eBook.

Device 10 includes a user interface 11, a digital signal processing unit (DSP) 12, a data storage unit 14, a memory unit 16, and a display element or unit 18. User interface 11, data storage unit 14, memory unit 16, and display unit 18 are coupled to DSP 12 via signal transmission buses. In accordance with the present invention, DSP 12 may include a microprocessor (μP), a microcontroller (μC), a central processing unit (CPU), or the likes. Data storage unit 14 may include one or more nonvolatile memory units such as, for example, a magnetic hard disc, an optical memory disk, read only memory (ROM), flash memory, ferroelectric random access memory (FeRAM), magentoresistive random access memory (MRAM), etc. Memory unit 16 may include a cache memory unit or a volatile memory unit such as, for example, dynamic random access memory (DRAM), static random access memory (SRAM), zero capacitor random access memory (Z-RAM) twin-transistor random access memory (TTRAM), etc. Display unit 18 may include a video display of various kinds, such as, for example, liquid crystal display (LCD), cathode ray tube display (CRT), electroluminescent display (ELD), light emitting diode display (LED), etc. In accordance with the present invention, device 10 may include additional elements not shown in FIG. 1. For example, device 10 may also include an audio system, a radio, a global positioning system (GPS), etc.

In accordance with the present invention, user interface 11 may include a keypad, a touchpad, a tracking ball, a touchless sensing pad, or any combination thereof In accordance with a preferred embodiment of the present invention, user interface 11 includes a sensing pad 21, which may be, by way of example, a touchpad or a touchless sensing pad, overlapping with at least a portion of the display panel (not shown in FIG. 1) in display unit 18, thereby allowing a user to mark and track the content shown on display unit 18 with a finger or a pointed object, e.g., a stylus. Preferably, sensing pad 21 also allows the user to input commands or data by writing or sketching thereon. In accordance with another embodiment of the present invention, a keypad pattern can be formed on sensing pad 21 and the user can input data via the alphanumeric keys in the pattern.

In operation, DSP 12 processes user commands and data inputs and generates operation codes to data storage unit 14, memory unit 16, and display unit 18. For example, when a user wants to read a chapter in a book stored in e-book 10, the user may uses a keyboard or keypad (not shown in FIG. 1) to input the book title and the chapter number into e-book 10. In response to the user input, DSP 12 searches data storage unit 14 for the corresponding book and chapter. After finding the book and chapter matching the user input, DSP 12 stores at last a portion of the chapter in memory unit 16. In response to user instructions, DSP 12 selects data in memory unit 16 and displays them on display unit 18.

In accordance with a preferred embodiment of the present invention, the user may use a finger or a pointed object, e.g., a stylus, to sketch on sensing pad 21 overlapping with at least a portion of display unit 18. In accordance with one embodiment, the user may track or mark a passage by underlining the passage on display unit 18. In accordance with another embodiment, the user may track or mark a passage by placing a finger or a pointed object over sensing pad 21 first at a point near the beginning of the passage and then at a point near the end of the passage. In accordance with yet another embodiment, the user may track or mark a passage by drawing a closed track or a loop on sensing pad 21 enclosing the passage. In accordance with a further embodiment, the user may track or mark a passage by dragging a finger or a pointed object over sensing pad 21 to form a first coordinate at the upper or left of the track and a second coordinate at the lower or right of the track corresponding to the beginning and the end, respectively, of the passage. In response to the user marking a passage, DSP 12 captures the marked passage and stores it in a nonvolatile memory space. In accordance with a preferred embodiment of the present invention, the nonvolatile memory space is located within data storage unit 14. In accordance with one embodiment, DSP 12 generates a copy the marked passage and stores the copy in the nonvolatile memory space. In accordance with another embodiment, DSP 12 generates two pointers pointing to the coordinates corresponding to the beginning and the end of the marked passage and stores the pointers in the nonvolatile memory space. Preferably, DSP 12 is capable of capturing multiple passages marked by the user and storing them in the nonvolatile memory space. Since the marked passages are stored in the nonvolatile memory space, they would not be lost when device 10 is switched off. The user may view the marked passages later. In accordance with a preferred embodiment of the present invention, DSP 12 attaches a flag or label to each marked passage in the nonvolatile memory space, thereby enabling the user to selectively display the marked passages on display unit 18 at a later time.

In accordance with a preferred embodiment of the present invention, in response to the user points to a predetermined area on sensing pad 21, e.g., an area on display unit 18 corresponding to the right margin on a printed book, DSP 12 opens a data input or dialogue window or box. The user may enter data in the data input window by sketching on sensing pad 21, using alphanumeric keys, or a combination thereof DSP 12 generates a flag or tab indicating the coordinate of the data input window and stores the coordinate and the user entered data in a nonvolatile memory space. In accordance with a preferred embodiment of the present invention, the nonvolatile memory space is located in data storage unit 14. Preferably, DSP 12 is capable of generating multiple data input windows and storing multiple sets of user entered data. Since the user entered data are stored in the nonvolatile memory space, they would not be lost when device 10 is switched off. The user may selectively view the data input windows or the user entered data at a later time.

In accordance with the present invention, the above described functions can be achieved via an algorithm implemented in DSP 12. In accordance with a preferred embodiment, the algorithm includes executable programs stored in a memory unit, e.g., a ROM unit, in device 10. In accordance with another preferred embodiment, the algorithm includes firmware codes embedded in device 10. In accordance with yet another preferred embodiment, the algorithm includes programs implemented in device 10 through hardware configuration.

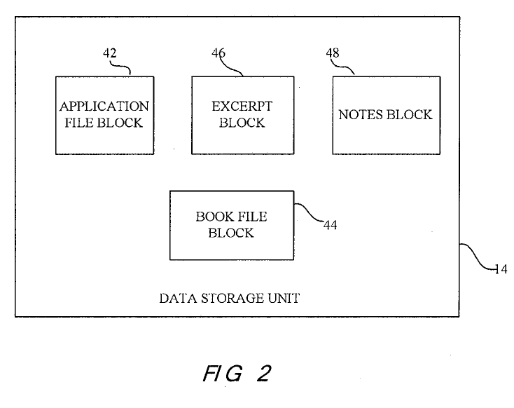

FIG. 2 is a block diagram illustrating a functional structure of data storage unit 14 in a digital media device 10 shown in FIG. 1 in accordance with an embodiment of the present invention. As shown in FIG. 2, data storage unit 14 is partitioned into multiple folders, sections, or blocks for storing different types of data in accordance with the present invention. In accordance with a preferred embodiment of the present invention, data storage unit 14 includes an application file folder, section, or block 42, a book file folder, section, or block 44, an excerpt folder, section, or block 46, and a notes folder, section, or block 48. Application file block 42 stores the executable program codes of the applications for the operation of device 10. Book file block 44 stores the contents of the documents or books and other data files. Excerpt block 46 stores the passages marked by the user as described herein above with reference to FIG. 1. Notes block 48 stores the notes entered by the user as described herein above with reference to FIG. 1. In accordance with a preferred embodiment of the present invention, the partition of data storage unit 14 into various memory blocks is dynamic. The sizes of the blocks may change to efficiently accommodate the amounts of data in different blocks. In addition, a specific block, e.g., excerpt block 46 or notes block 48, may be generated on demand and deleted when not in use. Preferably, when there is no marked passage or user entered note, excerpt block 46 or notes block 48 may be deleted to provide additional memory space for other blocks.

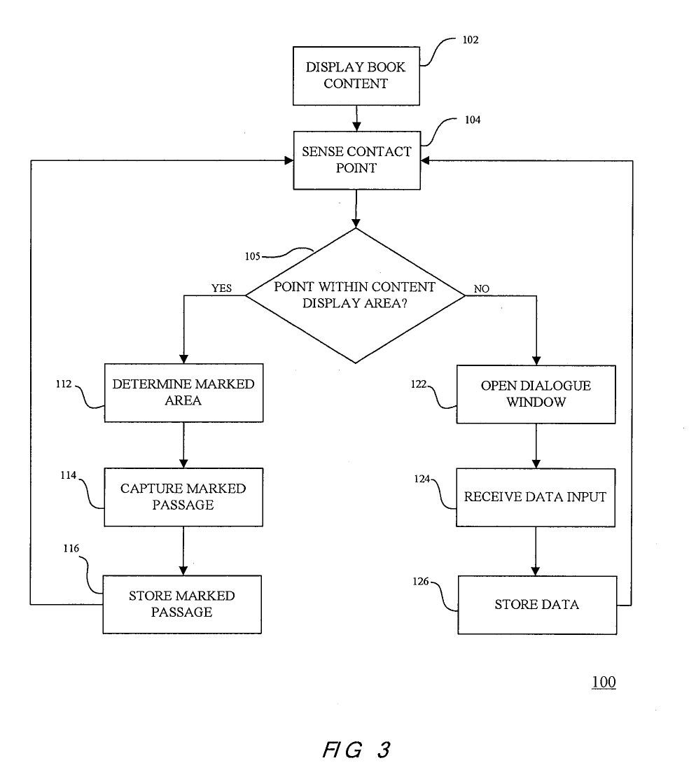

FIG. 3 is a flowchart illustrating a data management process 100 in accordance with an embodiment of the present invention. By way of example, data management process 100 may be implemented in electronic device 10 shown in FIG. 1. However, this is not intended as a limitation on the scope of the present invention. In accordance with the present invention, process 100 can be implemented in other electronic devices having a nonvolatile memory unit.

In a step 102, the content of a book file or document is displayed on a display panel of an electronic device, e.g., e-book 10 described herein above with reference to FIG. 1. In accordance with a preferred embodiment of the present invention, the book document content is display page by page. Preferably, a reader may turn the page displays forward or backward, skip pages, etc., like reading a conventional printed book.

In a step 104, a sensing pad in the device overlapping with at least a portion of the display panel senses the reader placing a pointed object, e.g., a stylus or a finger tip, over a point on the display panel. In accordance with a preferred embodiment, step 104 also identifies the coordinate of the point. In a step 105, process 100 checks whether the point is within or without an area where the content of the book or document is displayed. Generally, a reader would track or mark a passage in the book by placing the pointed object over a point within the area of book display. On the other hand, the reader would generally make a note when he places the pointed object over a point outside the area of book display.

In response to the point being within the area of book display, process 100 proceeds to a step 112 to determine the area of the marked passage. In accordance with one embodiment, the reader marks a passage by underlining the passage. Step 112 records the coordinate of the point where the pointed object first touches or overlies the display panel and traces the object movement over the display panel to determine the area of the marked passage. In accordance with another embodiment, the user may track or mark a passage by placing the pointed object over the display panel first at a point near the beginning of the passage and then at a point near the end of the passage within a predetermined time interval, e.g., between approximately 0.5 second and approximately 5 seconds. Step 112 records the coordinates of the two points to determine the area of the marked passage. In accordance with yet another embodiment, the user may track or mark a passage by drawing a loop on the display panel enclosing the passage. Step 112 records the coordinates of the loop to determine the area of the marked passage. In accordance with a further embodiment, the user may track or mark a passage by dragging a pointed object over sensing pad 21. Step 112 records two coordinates corresponding to the upper or left and the lower or right to determine the area of the marked passage.

In a subsequent step 114, process 100 captures the marked passage within the area determined in step 112. Step 114 also generates a flag or label corresponding to the marked passage. In accordance with a preferred embodiment of the present invention, the flag or label identifies the marked passage and its location in the book. The location in the book may include the titles of the chapters, sections and the paragraph numbers within the chapters, or sections of the marked passages associated with reader entered notes.

In a step 116, process 100 stores the flag and the marked passage in a nonvolatile memory space. In accordance with one embodiment, step 116 generates a copy of the marked passage and stores the copy in the nonvolatile memory space. In accordance with another embodiment, step 116 generates two pointers pointing to the coordinates corresponding to the beginning and the end of the marked passage in the book content and stores the pointers in the nonvolatile memory space.

In response to the point being without the area of book display, process 100 proceeds to a step 122 to open a data input or dialogue widow for the reader to input notes. The point being outside the book display area corresponds to the reader pointing to the margin area of the book, which generally indicates that the reader intends to input notes,

In a step 124, process 100 receives the reader data input in the dialogue window.

In accordance with the present invention, the reader may enter data in the dialogue window by sketching on the display panel, using alphanumeric keys, or a combination thereof. Step 124 also generates a flag or tab indicating the coordinate of the data input window. The coordinate establishes a corresponding relationship between the reader entered notes and specific passages in the book.

In a subsequent step 126, process 100 stores the coordinate and the reader entered data in a nonvolatile memory space. In accordance with the present invention, the reader entered data may be stored as a text file, an image file, a spreadsheet file, etc. Furthermore, a reader entered note corresponding to a passage in the book may be combined with other notes corresponding to other passages in the book in a file.

After storing the marked passage in step 116 or storing the reader entered note in step 126, process 100 returns to step 104 to sense the reader's next action.

It should be understood that data management process 100 in accordance with the present invention is not limited to being identical to that described herein above. Process 100 may include additional steps or additional features as desired. For example, the flags or labels attached to the marked passages and user entered data may include a user identifier in accordance with a preferred embodiment of the present invention. This is beneficial on an electronic device with multiple user access. Each user has an identifier, e.g., a login ID. The user identifier in the flags allows multiple users to read a book, mark passages on the book, and make notes while reading the book without interfering with each other. In accordance with another preferred embodiment of the present invention, the flags or label include timestamps indicating the times when the user marked the passages or made the notes.

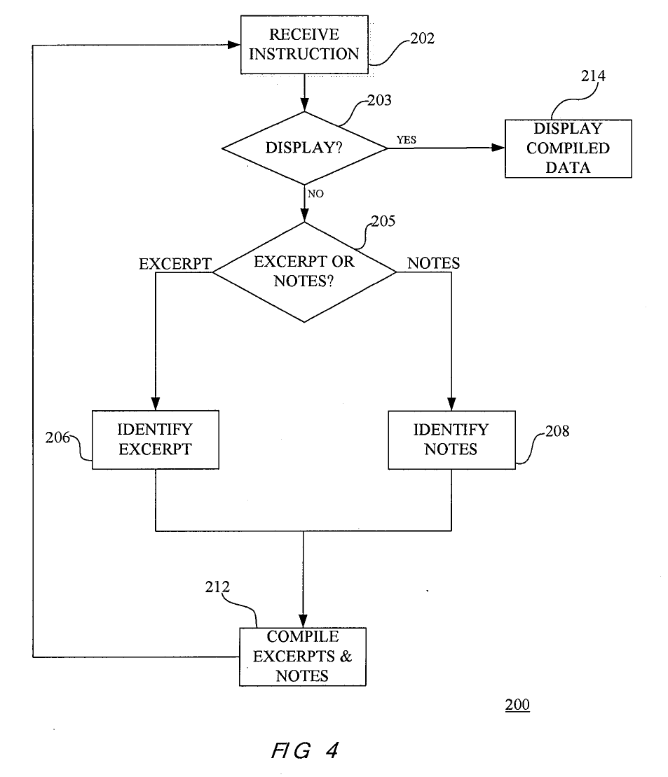

FIG. 4 is a flowchart illustrating a process 200 for compiling and displaying marked passage and notes in accordance with an embodiment of the present invention. By way of example, data compilation and display process 200 may be implemented in electronic device 10 shown in FIG. 1 in combination with data management process 100 described herein above with reference to FIG. 3. However, this is not intended as a limitation on the scope of the present invention. In accordance with the present invention, process 200 can be implemented in other types of electronic devices having a nonvolatile memory unit.

In accordance with an embodiment of the present invention, process 200 is implemented on an electronic device, e.g., an e-book. The e-book has a nonvolatile memory for storing the content of a book or document. In accordance with a preferred embodiment of the present invention, the nonvolatile memory also stores passages of the content marked by a reader. In accordance with one embodiment, the e-book stores the contents of marked passages. In accordance with another embodiment, the e-book stores pointers pointing to the locations of the marked passages in the book content. In accordance with another preferred embodiment of the present invention, the nonvolatile memory stores data entered by a reader as notes while reading the book.

In a step 202, data compilation and display process 200 receives reader instruction with respect to the compilation and display of the previous marked passages or reader entered data. In accordance with a preferred embodiment of the present invention, a reader instruction may be selecting a previously marked passage or excerpt for compilation, selecting a previously entered data or note compilation, or displaying the compiled data. Process 200 identifies whether the instruction type is a displaying instruction or a compiling instruction in a step 203. In response to a reader instruction as a compiling instruction, process 200 proceeds to a step 205 to identify whether the reader compiling instruction selects an excerpt or a note for compilation.

In response to a reader of selecting a previous marked passage or excerpt for compilation, a step 206 in process 200 identifies the selected excerpt. In accordance with a preferred embodiment of the present invention, the identified excerpt is a passage in the book previously marked in a data management process, e.g., process 100 described herein above with reference to FIG. 3 and stored in a nonvolatile memory unit, e.g., data storage unit 14 in e-book 10 as shown in FIG. 1. In accordance with a preferred embodiment of the present invention, passage identifying step 206 includes identifying the selected passages by their flags or labels, locations in the book, addresses in the memory space, etc.

In response to a user instruction of selection a previous entered note for compilation, a step 208 in process 200 identifies the selected note. In accordance with a preferred embodiment of the present invention, the identified note is previously entered in a data management process, e.g., process 100 described herein above with reference to FIG. 3 and stored in a nonvolatile memory unit, e.g., data storage unit 14 in e-book 10 as shown in FIG. 1. In accordance with a preferred embodiment of the present invention, notes identifying steps 208 include identifying the selected notes by their flags or labels, locations in the book, addresses in the memory space, etc.

In a step 212, process 200 combines the reader selected excerpt and the reader selected notes in a compiled data memory space. In accordance with one embodiment, the compiled data memory space includes a memory space in a nonvolatile memory unit, e.g., data storage unit 14 in device 10 as shown in FIGS. 1 and 2. In accordance with another embodiment, the compiled data memory space includes a memory space in a volatile memory unit, e.g., temporary memory unit 16 in device 10 as shown in FIG. 1. After data compiling step 212, process 200 returns to step 202 waiting for the next instruction from the reader.

In response to a reader instruction for displaying the compiled data, process 200 proceeds to a step 214 to display the data compiled in step 212. In accordance with the present invention, step 214 may display the compiled data in a text file, a image file, etc. In accordance with one preferred embodiment, step 214 displays the excerpts and notes compiled in step 212 in an order corresponding to their locations in the book. In accordance with another preferred embodiment, step 214 displays the excerpts and notes compiled in step 212 in an order corresponding to a sequence they are selected by the reader in steps 202, 206, and 208. The compiled data may include selected excerpts from the book and selected reader entered notes compiled together in step 212. In accordance with a preferred embodiment of the present invention, step 214 also displays the times at which the reader marked the excerpts or made the notes. In accordance with another preferred embodiment of the present invention, step 214 also displays the identity of the reader who marked the excerpts or made the notes. In accordance with yet another preferred embodiment of the present invention, step 214 also displays the locations in the book of the corresponding excerpts or the corresponding notes.

By now it should be appreciated that a digital media device and a method for customizing the data for display on the digital media device have been provided. In accordance with the present invention, the digital media device includes an algorithm implemented thereon for managing and compiling data for display on the device. In accordance with an embodiment, the user can track or mark passages in a file on display and the method stores the user marked passages in a nonvolatile memory. In accordance with another embodiment, the user can enter data while reading the file, and the method stores the user entered data in a nonvolatile memory. At the user's request, the method can compile the data and display the marked passages, the user entered data, or both. In accordance with the present invention, the method generates a coordinate representing the location in the file where the user enters the data, thereby by establishing a correspondence between the user entered data and the content of the file.

An application of the digital media device and the data management and compilation method is in the area of e-books. The method enables a reader to select certain passages in a book for reading at a later time. The method also enables the reader to make notes while reading the book and read those notes with the corresponding book contents later. These features are especially beneficial to the readers of the educational books, and science and technology materials.

While specific embodiments of the present invention have been described herein above, they are not intended as limitations on the scope of the invention. The present invention encompasses those modifications and variations of the described embodiments that are obvious to those skilled in the art. For example, an electronic device capable of customizing the content display is not limited to being as an e-book as described above. It can be any other kind of devices such as, for example, a mobile telephone, a personal digital assistant, a laptop computer, a desktop computer, etc. Also by way of example, an e-book that is only capable of selecting and compiling the user marked excerpts for display is within the scope of the present invention. Likewise, an e-book capable of only compiling user entered notes for display is also within the scope of the present invention.

1. An electronic device (10) for displaying a document, comprising:
a user interface (11) and a display element (18);
a nonvolatile memory unit (14) including a first memory block (44) configured to store the document and a second memory block (46);
a digital signal processing unit (12) coupled to said user interface (11), said display element (18), and said nonvolatile memory unit (14); and
said digital signal processing unit (12) being configured to store a passage in the document in the second memory block (46) of said nonvolatile memory unit (14) in response to a first instruction received through said user interface (11) and to display the passage on said display element (18).

2. The electronic device (10) of claim 1, wherein said user interface (11) includes a sensing pad (21) overlapping with a portion of said display element (18).

3. The electronic device (10) of claim 1, wherein:
said nonvolatile memory unit (14) further includes a third memory block (48); and
said digital signal processing unit (12) is further configured to store user entered data in the third memory block (48) in said nonvolatile memory unit (14) and display the user entered data on said display element (18).

4. The electronic device (10) of claim 3, wherein said digital signal processing unit (12) is configured to store a plurality of passages to the second memory block (46) in said nonvolatile memory unit (14) and store a plurality of user entered data in the third memory block (48) in said nonvolatile memory unit (14).

5. The electronic device (10) of claim 4, wherein said digital signal processing unit (12) is further configured to compile the plurality of passages and the plurality of user entered data for display on said display element (18).

6. A data management process, comprising the steps of:
displaying a content of a book file in a first area on a display panel;
receiving a note by opening a dialogue window in response to a user pointing to a second area on the display panel outside the first area;
storing the note in a block in a nonvolatile memory unit; and
displaying the note on the display panel.

7. The data management process as claimed in claim 6, wherein the step of compiling the note includes generating a label indicating a correspondence relationship between the note a location in the content of the book file.

8. The data management process as claimed in claim 6, further comprising the steps of:
capturing a passage in the content of the book file in response to the user marking the passage in the first area on the display panel;
storing the passage in a second block in the nonvolatile memory unit;
compiling the passage and the note; and
displaying the passage and the note on the display panel.

9. The data management process as claimed in claim 8, wherein:
the step of receiving a note includes receiving a plurality of notes; and
the step of capturing a passage in the content of the book file includes capturing a plurality of passages.

10. The data management process as claimed in claim 8, wherein the step of storing the passage in a second block in a nonvolatile memory unit includes storing a pointer pointing to the passage in the content of the book in the second block of the nonvolatile memory unit.

11. A method for managing data for display, comprising:
displaying a document on a display panel;
capturing a passage in the document in response to a user marking the passage;
storing the passage in a block in a nonvolatile memory unit;
compiling the passage; and
displaying the passage on the display panel.

12. The method as claimed in claim 11, wherein capturing a passage in the document in response to a user marking the passage includes marking the passage in response to the user marking a first point corresponding to a coordinate of a beginning of the passage and a second point correspond to a coordinate of an end of the passage.

13. The method as claimed in claim 11, wherein capturing a passage in the document in response to a user marking the passage includes marking the passage in response to the user underlining the passage.

14. The method as claimed in claim 11, wherein capturing a passage in the document in response to a user marking the passage includes marking the passage in response to the user forming a track enclosing the passage.

15. The method as claimed in claim 11, wherein capturing a passage in the document in response to a user marking the passage includes marking the passage in response to the user dragging over the display panel to form a first coordinate at upper or left and a second coordinate at lower or right corresponding to a beginning and an end, respectively, of the passage.

16. The method as claimed in claim 11, further comprising:
receiving a user entered note;
storing the user entered note in a second block in the nonvolatile memory unit;
compiling the user entered note; and
displaying the note on the display panel.

17. The method as claimed in claim 16, wherein:
displaying a document on a display panel includes displaying the document in a first area on the display panel;
receiving a user entered note includes opening a dialogue window in response to the user pointing to a second area in the display panel outside the first area.

18. The method as claimed in claim 16, wherein:
capturing a passage in the document includes capturing a plurality of passages; and
receiving a user entered note includes receiving a plurality of user entered notes.

19. The method as claimed in claim 16, wherein compiling the user entered note includes generating a label indicating a correspondence relationship between the user entered note a location in the document.

20. The method as claimed in claim 11, wherein storing the passage in a block in a nonvolatile memory unit includes storing a pointer pointing the passage in the document in the block of the nonvolatile memory unit.
